(19) United States
(12) Patent Application Publication
(10) Pub. No.: US 2026/0102782 A1
(43) Pub. Date: Apr. 16, 2026

(54) Switching Device for Pneumatic Spray Gun

(71) Applicants: Hai Wu, Taizhou (CN); Zhengxing Ying, Taizhou (CN); Xiaorong Li, Taizhou (CN); Xiaopeng Li, Taizhou (CN); Qin Li, Taizhou (CN)

(72) Inventors: Hai Wu, Taizhou (CN); Zhengxing Ying, Taizhou (CN); Xiaorong Li, Taizhou (CN); Xiaopeng Li, Taizhou (CN); Qin Li, Taizhou (CN)

(21) Appl. No.: 18/916,717

(22) Filed: Oct. 16, 2024

(51) Int. Cl. B05B 7/12; B05B 12/00

(52) U.S. Cl. CPC B05B 7/12; B05B 12/002

(57) ABSTRACT

A switching device for a pneumatic spray gun, comprising a gun body, a switch rod movably installed back and forth within a switch channel of the gun body, a material adjustment nut screwed onto the rear end of the switch channel, and a material needle inserted into a central hole of the switch rod. The rear end of the switch rod is provided with a rear sealing ring, and the front end of the switch rod is provided with a front sealing ring and a switch sleeve. The switch sleeve presses the front sealing ring tightly. A valve spring is arranged between the material adjustment nut and the switch rod, with the front end of the valve spring abutting against the switch rod, and the rear end connected to the material adjustment nut via a flat washer and an O-shaped sealing ring.

### FIELD OF THE INVENTION

The present invention relates to a switching device for a pneumatic spray gun.

### BACKGROUND OF THE INVENTION

A pneumatic spray gun is a spraying device that utilizes the rapid release of compressed air as power. Compressed air is supplied into the interior of the gun body through an air inlet pipe. When high-pressure compressed air is ejected from the air cap at the front of the gun nozzle, it creates a negative pressure area lower than atmospheric pressure at the front of the paint nozzle. This pressure difference at the gun nozzle draws paint out from the paint reservoir. Under the action of the high-speed jet force of the compressed air, the paint is atomized into fine particles and sprayed onto the surface of the object being coated.

In the prior art, the components constituting the switching device of a pneumatic spray gun are numerous, making assembly inconvenient, and the machining accuracy requirements for the components are relatively high. This results in a higher defect rate of the assembled finished products. Specifically, the sealing assembly structure between the rear end of the switch rod and the gun body is usually metal-to-metal, which imposes high requirements on roundness and coaxiality. Products often have leakage problems caused by factors such as machining and assembly. This has been a longstanding difficulty and pain point in the industry.

### SUMMARY OF THE INVENTION

In view of the shortcomings in the aforementioned issues, the present invention provides a switching device for a pneumatic spray gun.

To achieve the above objective, the present invention provides a switching device for a pneumatic spray gun, including a gun body, a switch rod movably installed back and forth within a switch channel of the gun body, a material adjustment nut screwed onto the rear end of the switch channel, and a material needle inserted into a central hole of the switch rod. The rear end of the switch rod is equipped with a rear sealing ring, and the front end is equipped with a front sealing ring and a switch sleeve. The switch sleeve presses the front sealing ring tightly. A valve spring is arranged between the material adjustment nut and the switch rod, with the front end of the valve spring abutting against the switch rod, and the rear end connected to the material adjustment nut via a flat washer and an O-shaped sealing ring. A material adjustment screw is screwed onto the material adjustment nut, within which a material adjustment spring is installed. The material adjustment spring elastically supports the shoulder position of the material needle.

Further, the gun body is also provided with a rotatable trigger.

Further, both the front and rear sealing rings are made of acid-resistant plastic, and the sealing surface between the rear sealing ring and the gun body is a flat surface.

The invention has the following features:
The switching device has a simple structure with fewer components that are easy to process and form. The overall assembly is simple and quick, which helps improve assembly efficiency and ensure a higher pass rate of assembled products.
Both the front and rear sealing rings are made of acid-resistant plastic. Even if the pneumatic spray gun is immersed in acidic solutions for a long time, the internal air path of the spray gun is not easily corroded, ensuring the normal functioning of the spray gun.
The sealing surface of the rear sealing ring is a flat surface, which achieves better sealing performance and reduces the likelihood of air leakage.

### BRIEF DESCRIPTION OF THE DRAWINGS

FIG. 1 is a perspective view of the switching device for a pneumatic spray gun according to the present invention.

FIG. 2 is a sectional view of the switching device for a pneumatic spray gun according to the present invention.

### DETAILED DESCRIPTION OF THE EMBODIMENTS

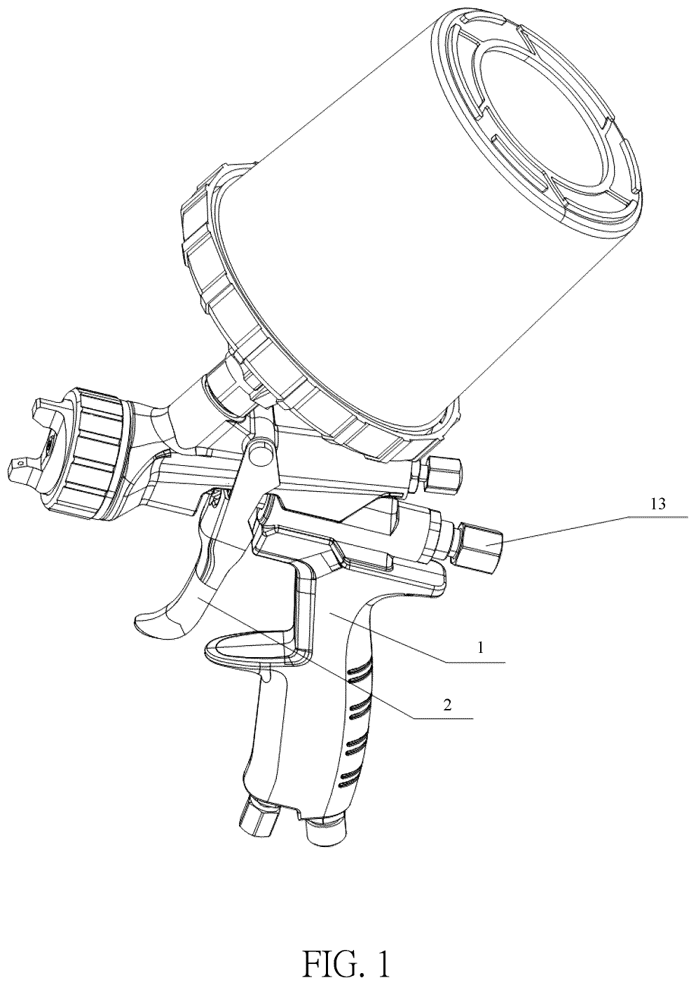

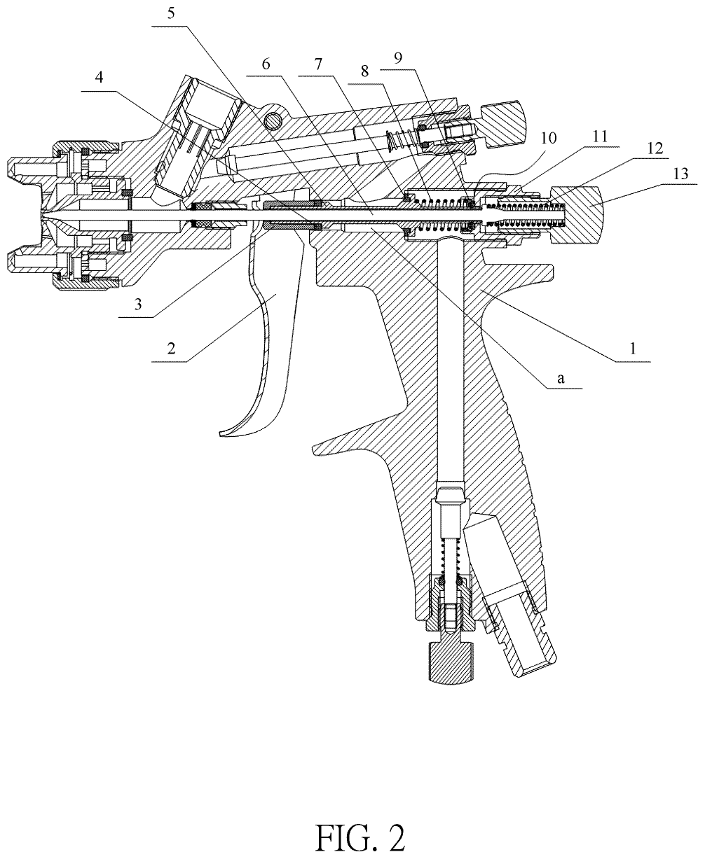

As shown in FIGS. 1 and 2, an embodiment of the switching device for a pneumatic spray gun according to the present invention includes a gun body (1), a switch rod (5) movably installed back and forth within a switch channel (a) of the gun body (1), a material adjustment nut (11) screwed onto the rear end of the switch channel (a), and a material needle (6) inserted into a central hole of the switch rod (5). The rear end of the switch rod (5) is equipped with a rear sealing ring (7), and the front end is equipped with a front sealing ring (4) and a switch sleeve (3). The switch sleeve (3) presses the front sealing ring (4) tightly. A valve spring (8) is arranged between the material adjustment nut (11) and the switch rod (5), with the front end of the valve spring (8) abutting against the switch rod (5), and the rear end connected to the material adjustment nut (11) via a flat washer (9) and an O-shaped sealing ring (10). A material adjustment screw (13) is screwed onto the material adjustment nut (11), within which a material adjustment spring (12) is installed. The material adjustment spring (12) elastically supports the shoulder position of the material needle (6). The gun body (1) is also provided with a rotatable trigger (2). Both the front sealing ring (4) and the rear sealing ring (7) are made of acid-resistant plastic, and the sealing surface between the rear sealing ring (7) and the gun body (1) is a flat surface.

The switching device has a simple structure with fewer components that are easy to process and form. The overall assembly is simple and quick, which helps improve assembly efficiency and ensure a higher pass rate of assembled products. Both the front and rear sealing rings are made of acid-resistant plastic. Even if the pneumatic spray gun is immersed in acidic solutions for a long time, the internal air path of the spray gun is not easily corroded, ensuring the normal functioning of the spray gun. The sealing surface of the rear sealing ring is a flat surface, which achieves better sealing performance and reduces the likelihood of air leakage.

For ease of understanding the present invention, the specific usage is described in conjunction with the accompanying drawings:
During the operation of the pneumatic spray gun, the supply of material lags behind the supply of air. In this patented design, the trigger (2) first pushes the switch rod (5) to move and overcomes the elastic force of the valve spring (8), allowing the air inlet of the pneumatic spray gun to connect the air path to the air cap, thereby supplying air. The trigger (2) continues to rotate, and the switch rod (5) drives the material needle (6) to move, opening the paint outlet at the front end of the material needle (6), thus achieving paint spraying.
The assembly process of the switching device for the pneumatic spray gun involved in this patent is as follows: First, install the rear sealing ring (7) on the rear end of the switch rod (5), then install the front sealing ring (4) on the front end of the switch rod (5), and finally press the switch sleeve (3) into the switch rod (5) to fix the front sealing ring (4). Place the assembled components into the switch channel (a) of the gun body (1), install the valve spring (8), flat washer (9), O-shaped sealing ring (10), and material adjustment nut (11), then insert the material needle (6), install the material adjustment spring (12) and material adjustment screw (13), and finally install the trigger (2) and secure it in place. Because the installation is more convenient and quick, the overall product pass rate is higher.

The above description is only a preferred embodiment of the present invention and is not intended to limit it. Various modifications and changes can be made to the present invention by those skilled in the art. Any modifications, equivalent replacements, or improvements made within the spirit and principles of the present invention should be included within its protection scope.

We claim

1. A switching device for a pneumatic spray gun, comprising:
a gun body (1), a switch rod (5) movably installed back and forth within a switch channel (a) of the gun body (1), a material adjustment nut (11) screwed onto a rear end of the switch channel (a), and a material needle (6) inserted into a central hole of the switch rod (5),
wherein the rear end of the switch rod (5) is provided with a rear sealing ring (7),
the front end of the switch rod (5) is provided with a front sealing ring (4) and a switch sleeve (3),
the switch sleeve (3) presses the front sealing ring (4) tightly,
a valve spring (8) is arranged between the material adjustment nut (11) and the switch rod (5),
the front end of the valve spring (8) abuts against the switch rod (5),
the rear end of the valve spring (8) is connected to the material adjustment nut (11) via a flat washer (9) and an O-shaped sealing ring (10),
a material adjustment screw (13) is screwed onto the material adjustment nut (11),
the material adjustment screw (13) contains a material adjustment spring (12) installed therein,
the material adjustment spring (12) elastically supports the shoulder portion of the material needle (6).

2. The switching device for a pneumatic spray gun according to claim 1, wherein the gun body (1) is further provided with a rotatable trigger (2).

3. The switching device for a pneumatic spray gun according to claim 1, wherein both the front sealing ring (4) and the rear sealing ring (7) are made of acid-resistant plastic, and the sealing surface between the rear sealing ring (7) and the gun body (1) is a flat surface.
